(19) United States
(12) Patent Application Publication
(10) Pub. No.: US 2013/0327785 A1
(43) Pub. Date: Dec. 12, 2013

(54) Dispenser

(71) Applicant: Richard A. Koskela, Scottsdale, AZ (US)

(72) Inventor: Richard A. Koskela, Scottsdale, AZ (US)

(21) Appl. No.: 13/493,625

(22) Filed: Jun. 11, 2012

(51) Int. Cl. G07F 11/46

(52) U.S. Cl. 221/282

(57) ABSTRACT

A dispenser applies objects to a receptacle from a column of objects. The dispenser comprises a support defining a bore in which a vertically displaceable dispensing tube is positioned. The dispensing tube is prevented from excessive upward or downward displacement by physical impediments. The dispensing tube defines one or more notches that cooperate with one or more metering members and one or more channels in the support. The metering members displace outward when the notches and channels are aligned to permit objects to fall into a receptacle positioned below the dispensing tube. The metering members displace inward when the notches and channels are not aligned to prevent objects from falling into the receptacle.

### FIELD OF THE INVENTION

The present invention relates to apparatus and methods for dispensing objects and, more particularly, to apparatus and methods for sequentially dispensing objects from an elevated position using minimal components.

### BACKGROUND OF THE INVENTION

Dispensers are useful to large manufacturers, packagers, small businesses, and private users. Dispensers can deliver toothpaste, cash, labels, paper towels, candy, soap, pills, tape, gloves, beverages, and many other objects. Generally, they are useful for delivering items that need to be provided in discrete amounts. For example, dispensers are useful for delivering a prescribed amount of manufacturing materials during a manufacturing process. Similarly, dispensers are useful for placing products into packaging materials. Additionally, dispensers are used everyday directly by consumers to deliver consumables such as soap or food to the consumer in small quantities as needed.

A particular use for dispensers is to seat objects either into other components or directly into packaging. For example, dispensers are used to place pills into blister packs or bottles. Dispensers are also used to seat candy into wrappers, sports balls into tubes, bullets into casings, and tool bits into holders. For some applications, the dispensed object must be seated in a particular way. For example, a tool bit should be seated in a holder with careful attention to its orientation.

Often objects must be packaged by hand or they are delivered using complicated and expensive machinery that includes numerous moving parts. For some applications, a simple yet more efficient method of dispensing objects is desired. Additionally, for some applications, a dispenser that further assists with careful placement of objects is desired.

### SUMMARY OF THE INVENTION

A dispenser is configured to dispense objects into a receptacle when the receptacle is situated below the dispenser. The dispenser comprises a support with a central bore and a dispensing tube positioned in the central bore such that the dispensing tube can reciprocate vertically in the support. The dispensing tube defines a conduit in which objects can be stacked and further defines one or more notches in which one or more metering members are positioned. The support further defines an annular support channel around the perimeter of the central bore that cooperates with the metering members positioned in the dispensing tube notches. As the dispensing tube reciprocates in the support, the support channel and dispensing tube notches interact. When the support channel and dispensing tube notches are aligned, the metering member displaces laterally outward to clear the conduit and allow the objects to dispense. When the support channel and dispensing tube notches are not aligned, the metering member extends into the conduit and path of the objects and prevents the objects from dispensing.

The dispensing tube further includes upper and lower structures for limiting the vertical range of motion of the dispensing tube. When the dispensing tube is not dispensing objects, one or more retaining rings located on the upper portion of the dispensing tube rests on the upper surface of the support to prevent further downward vertical movement. When the dispensing tube is dispensing objects, an annular lower lip located near the lower end of the dispensing tube pushes against the lower surface of the support to restrict further upward vertical displacement.

To dispense objects with the dispenser, a receptacle is positioned below the dispenser tube. The receptacle interacts with the lower end of the dispensing tube or with the conduit defined by the dispensing tube so that upwards pressure from the receptacle causes the dispensing tube to reciprocate upwards. When the dispensing tube reaches an upper position, the dispensing tube notches and support channel are aligned and further upward displacement of the tube is prevented by the annular lower lip. The metering member then displaces at least partially into the support channel due to the weight of the objects resting on the metering members. As the metering member displaces, the object is dispensed into the receptacle. The receptacle is then removed, and gravity causes the dispensing tube and metering member to return to their original position.

### BRIEF DESCRIPTION OF THE DRAWINGS

FIG. 1 is a side cutaway view of a receptacle and an embodiment of the dispenser of the present invention cut along line B-B shown in FIG. 2.

FIG. 2 is a top cutaway view of the embodiment shown in FIG. 1 cut along line A-A illustrating the position of the metering member when the support channel and tube notch are not aligned.

FIG. 3 is a top cutaway view of the embodiment shown in FIG. 1 cut along line A-A illustrating the position of the metering member when the support channel and tube notch are aligned.

FIG. 4 is a fragmented plan view illustrating the position of the metering member of the present invention when the support channel and tube notch are not aligned.

FIG. 5 is a fragmented plan view illustrating the position of the metering member of the present invention when the support channel and tube notch are aligned.

FIG. 6A-6I are sequential cutaway side views of the dispenser and receptacle illustrating how the receptacle interacts with the dispenser to displace the dispensing tube and consequently dispense an object.

FIG. 7 is a side view of an alternative embodiment of the dispensing tube of the present invention.

### DETAILED DESCRIPTION OF PREFERRED EMBODIMENTS

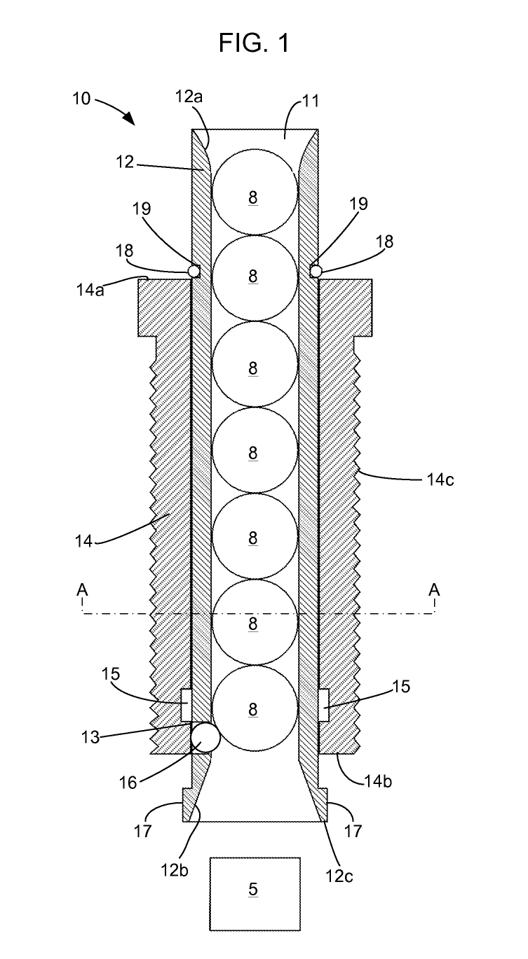

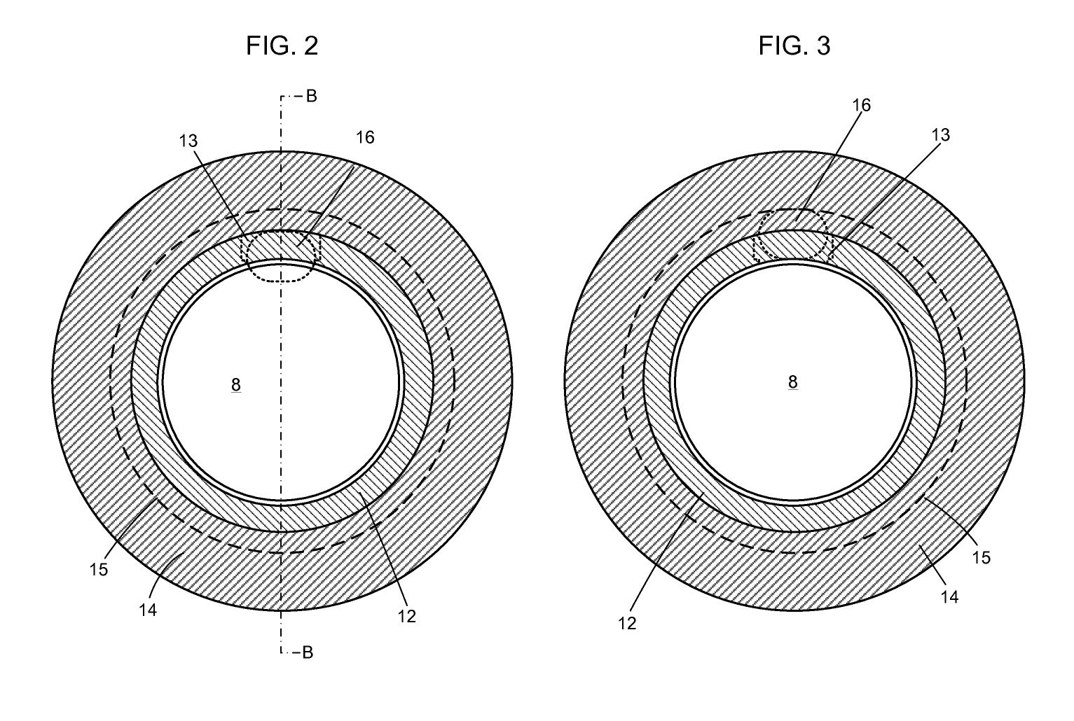

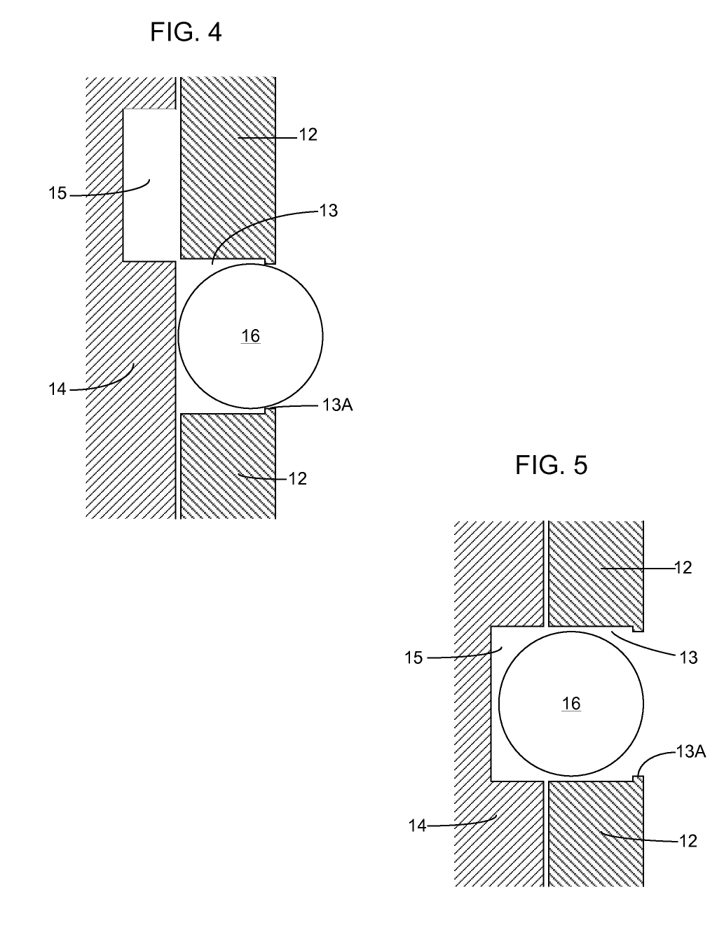

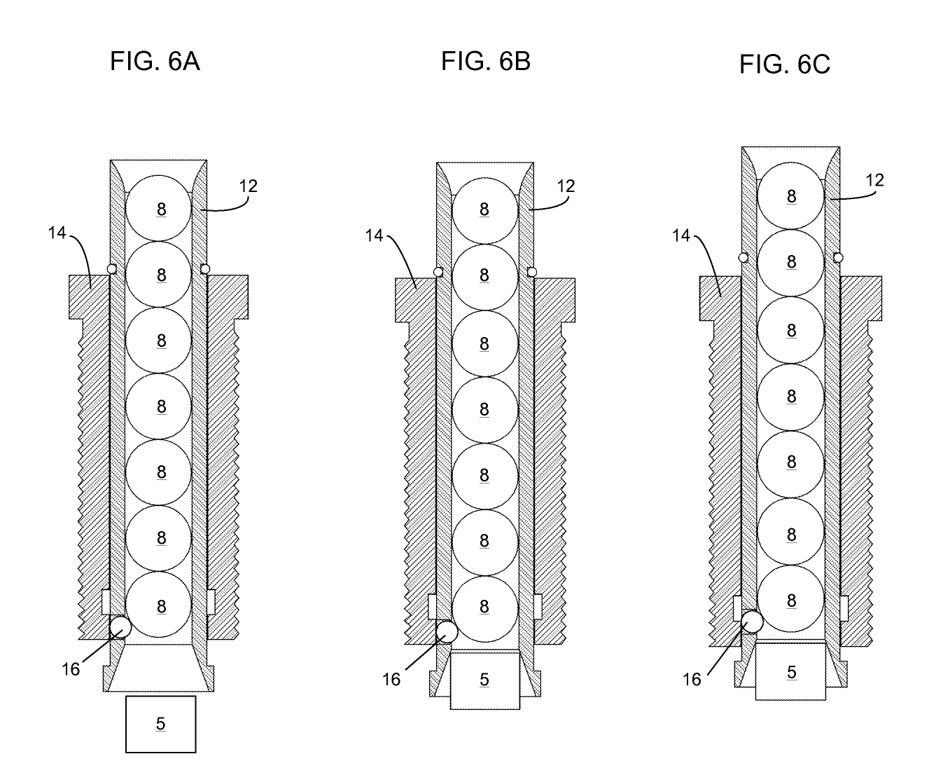

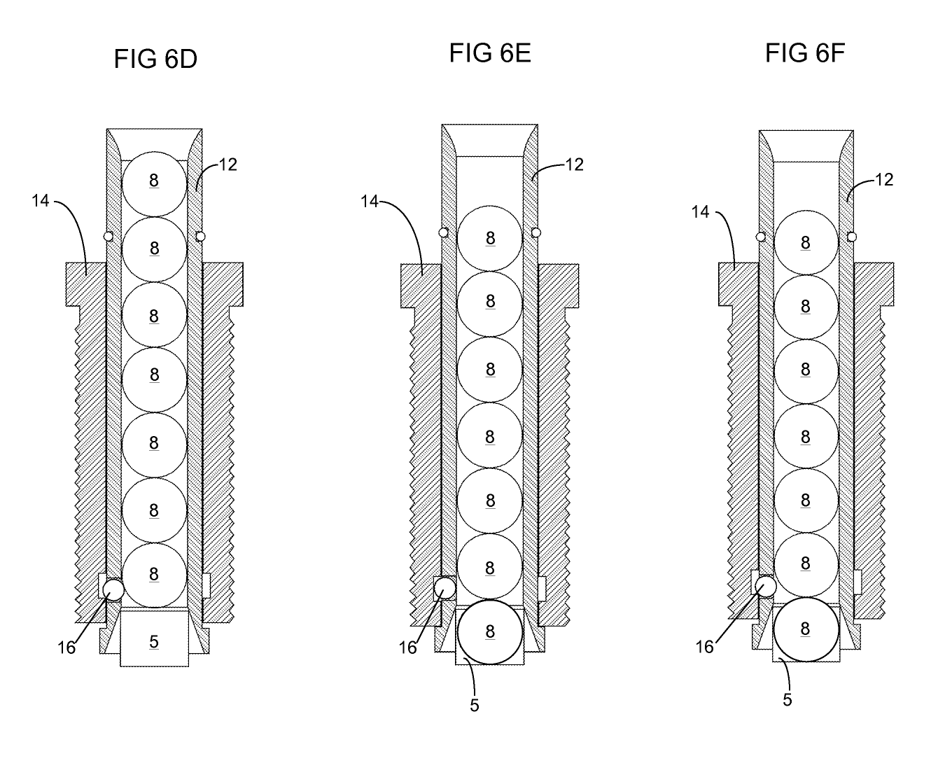

Turning now to the drawings, in which like reference characters indicate corresponding elements throughout the several views, attention is first directed to FIG. 1 illustrating the dispenser 10 of the present invention. As shown, dispenser 10 is configured to dispense objects 8 into a receptacle 5 when the receptacle 5 is situated below dispenser 10. Dispenser 10 includes a dispensing tube 12 and a support 14. Dispensing tube 12 defines a conduit 11 in which objects 8 can be stacked. Dispensing tube 12 also defines one or more tube notches 13 in which one or more metering members 16 can be housed. Support 14 defines a central bore (not labeled) through which dispensing tube 12 vertically reciprocates and an annular support channel 15 around the perimeter of the central bore. Support channel 15 cooperates with metering member 16. One or more metering members 16 are housed within one or more tube notches 13 such that the metering member 16 can be laterally displaced at least partially into the support channel 15 when the support channel 15 is aligned with the tube notches. FIGS. 2 and 4 illustrate the placement of metering member 16 when the support channel 15 and tube notch 13 are not aligned. FIGS. 3 and 5 illustrate the placement of metering member 16 when the support channel 15 and tube notch 13 are aligned.

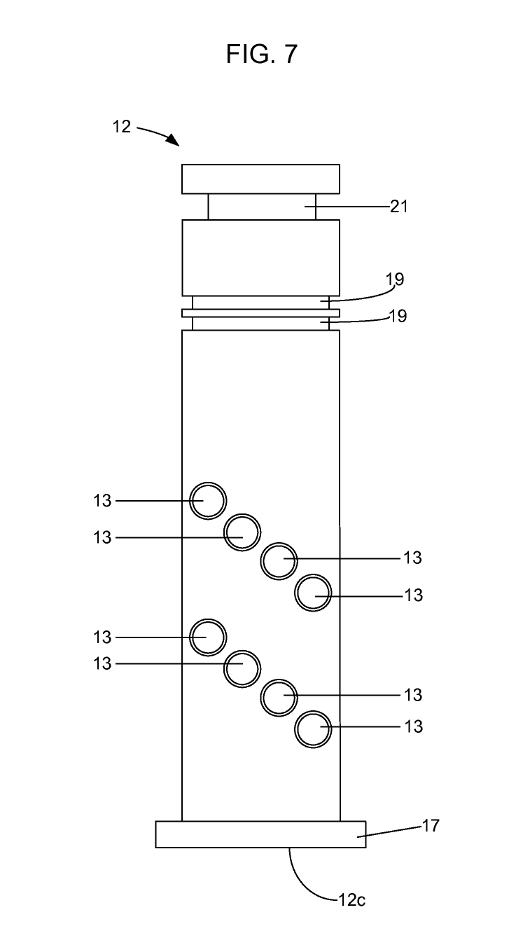

Dispenser tube 12 preferably also defines one or more blocking structures that limit the vertical range of motion of dispenser tube 12. For example, as shown, dispenser tube 12 defines an upper tube channel 19 around the outer perimeter of tube 12 in which a retaining ring 18 is housed. Retaining ring 18 restricts the downward range of motion of tube 12 when it engages the top surface 14a of support 14. One or more retaining rings 18 can be used in one or more upper tube channels 19. FIG. 7 illustrates an embodiment where two tube channels 19 are present to accommodate retaining rings 18 and where the operator of the dispenser can choose in which channel 19 to place the retaining ring according to the vertical range of motion desired. Additionally, dispenser tube 12 further defines an annular lower lip 17 around the outer perimeter of tube 12 near the lower end 12b of tube 12. Lower lip 17 restricts the upward range of motion of tube 12. Preferably, lower lip 17 is situated such that lower lip 17 engages the lower surface 14b of support 14 when support channel 15 and tube notches 13 are aligned. While a retaining ring 18 and lip 17 are illustrated, other structures or arrangements useful for restricting the reciprocal motion of an object can be substituted as will be known to someone skilled in the art. For example, retaining rings could be used in place of lower lip 17 and an upper lip could be used in place of retaining rings 18. Similarly, other motion-limiting structures can be used such as one or more protrusions, tapers, removable clips, or uneven surfaces.

Dispensing tube 12 also preferably includes features that facilitate loading objects 8 and engaging receptacles 5. As shown in the Figures, dispenser tube 12 and conduit 11 through dispensing tube 12 include an upper tapered end 12a and a lower tapered end 12b. Upper tapered end 12a tapers from a wide opening to a narrower passage to accommodate loading objects 8 into the conduit 11. Likewise, lower tapered end 12b tapers from the narrow passage to a wider opening as shown to accommodate receptacles of various sizes and shapes. Receptacles can either cooperate with the lower surface 12c of dispensing tube 12 or with the tapered surface 12b of the conduit formed by tube 12. While a gradual taper is illustrated in the Figures, other forms of taper are acceptable as well, such as a graduated tiers or steps, as will be known to someone skilled in the art. Additional features can be present on dispensing tube 12 as well to facilitate cooperation with additional machinery, tools, or devices. For example, as shown in FIG. 7, a groove 21 is formed in the outer surface of dispensing tube 12 to facilitate connecting dispensing tube 12 to additional machinery.

Support 14 can be any type of support structure. Preferably, support 14 is cylindrical with a threaded outer surface 14c so that it can be easily incorporated into other machinery. Alternatively, it can have a smooth surface and include mounting hardware. For some applications, support 14 can be a standalone unit and may include handles or additional support features. Support 14 can be constructed of any material suitable for cooperating with the material and shape of the objects being dispensed. The central bore defined by support 14 can be any shape as long as it cooperates with dispensing tube 12.

Dispensing tube 12 preferably has a circular cross-section, and the conduit 11 formed by dispensing tube 12 also preferably has a circular cross-section. Alternative cross-sections are acceptable, however, depending on the application desired. For example, for some applications a square or triangular cross-section of the tube 12 or conduit 11 may be desirable. The thickness of the tube is preferably uniform and sized to cooperate with metering members 16 so that metering members 16 extend into the conduit when the notches 13 are not aligned with the support channel 15. Dispensing tube 12 can be constructed of any material suitable for cooperating with the material and shape of the objects being dispensed.

The notches 13 defined by the dispensing tube 12 extend through the wall of the dispensing tube 12 and are shaped and sized to accommodate metering member 16. FIG. 7 illustrates notches shaped to accommodate spherical metering members 16, and FIGS. 1-5 illustrate notches shaped to accommodate an oblong metering member 16. Preferably, notches 13 are graduated in size such that a metering member 16 is prevented from laterally displacing entirely into conduit 11. FIGS. 4 and 5 illustrate a preferred notch 13 of the present invention. As shown, notch 13 has a notch lip 13A that restricts the inward lateral movement of the metering member 16. Notch 13 does not restrict outward lateral movement, or movement way from the conduit's center, however. In the preferred embodiment, support channel 15 prevents the metering member 16 from excessive outward lateral movement. In an alternative embodiment, a second notch lip (not shown) can be incorporated to prevent metering member 16 from displacing too far into the support channel 1415. In additional alternative embodiments, instead of incorporating a notch lip, notch 13 can taper in size or can include protrusions of other shapes or sizes that interfere with metering member 16 to limit excessive displacement. For ease of manufacturing the dispensing tube, however, a notch 13 with a single notch lip 13A is preferred.

Metering members 16 preferably have substantially circular or oval cross-sections and preferably have ends that are generally hemispherical. Further, metering members 16 generally have a length L that can vary according to the objects being dispensed. For example, length L can be such that the hemispherical ends join to form a sphere, or length L can be substantially longer than the radius of the hemispherical ends such that metering member 16 resembles a pencil or pen shape with hemispherical ends. Accordingly, metering member 16 will have a substantially circular first cross-section when viewed looking at the end of metering member 16 as in FIGS. 4 and 5 and a substantially oval second cross-section when viewed looking at the side of metering member 16 as in FIGS. 2 and 3. In alternative embodiments, metering members 16 can have other shapes as long as they can be laterally displaced in response to the weight of the objects 8 in the dispensing tube 12. Similarly, metering members 16 can be constructed of any material suitable for accommodating the weight and shape of the objects waiting to be dispensed.

Any number of metering members 16 and notches 13 can be placed around the perimeter of dispensing tube 12. In the preferred embodiment, the dispenser includes an odd number of metering members 16 and notches 13. In a more preferred embodiment, the dispenser includes one metering member 16 and one notch 13. For dedicated applications, such as for a dispenser that always dispenses gumballs of a given size, metering members 16 and notches 13 should be placed at the same vertical height relative to the lower surface 12c of the dispensing tube 12. For dispensers that may dispense a variety of objects, notches 13 can be placed at various vertical heights relative to lower surface 12c of dispensing tube 12 and metering members can be placed in the appropriately positioned notch 13 for the object being dispensed. FIG. 7 illustrates an embodiment of dispensing tube 12 where notches 13 that are shaped to cooperate with spherical metering members 16 are placed at various vertical heights. Additionally, to cooperate with notches 13 located at various vertical heights, additional support channels 15 can be incorporated in support 14 at various vertical heights. To ensure proper cooperation with notches 13 and metering members 16, additional vertical range of motion blocking structures can be incorporated, such as additional retaining rings 18, or moveable range of motion blocking structures can be incorporated, such as removable clips. Optionally, removable plugs also can be used to cover any support channels 15 that are not desired for a particular application.

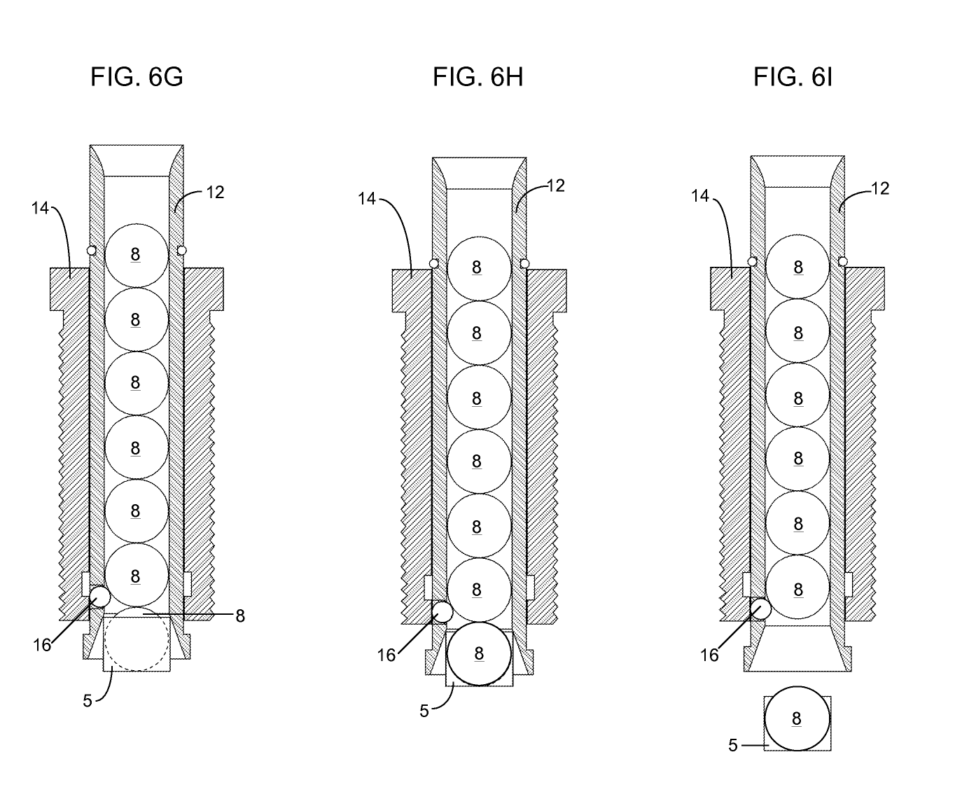

FIGS. 6A-6I illustrate the operation of dispenser 10. In FIG. 6A, receptacle 5 is positioned beneath dispensing tube 12, and metering member 16 is positioned in notch 13. Metering member 16 partially blocks conduit 11 and impinges on the lower most object 8 in the column, thereby supporting the column of objects above. Gravity maintains dispensing tube 12 in its lowest position; tube 12 being prevented from further downward travel by retaining ring 18, which contacts upper surface 14a of support 14.

In FIG. 6B, receptacle 5 raises and contacts conduit 11 at the tapered lower end 12b of dispensing tube 12. Alternatively, dispenser 10 could be lowered to contact receptacle 5 with the same result. In FIG. 6C, dispensing tube 12 begins to be vertically displaced upwards due to the upward force of receptacle 5 on tube 12. As shown in FIG. 6C, metering member 16 continues to partially block conduit 11 and thereby prevent objects 8 from falling into receptacle 5.

In FIG. 6D, receptacle 5 continues to apply an upwards force on dispensing tube 12 thereby causing dispensing tube 12 to continue to vertically displace upwards. Notch 13 is becoming aligned with the support channel 15, and metering member 16 is beginning to displace outward or away from the center of conduit 11 due to the pressure applied by object 8 resting on metering member 16. Object 8 applies pressure on metering member 16 due to the force of gravity acting on the column of objects 8.

In FIG. 6E, receptacle 5 and dispensing tube 12 have each reached their maximum upward travel. Metering member 16 has been forced laterally outward such that the metering members no longer protrude into conduit 11. The column of objects 8 are allowed to fall downward due to the influence of gravity, and receptacle 5 receives at least the lowermost object 8. As shown in FIGS. 6A-6I, receptacle 5 is sized to receive one object. Additional objects 8 can be received by a larger or deeper receptacle if desired.

In FIG. 6F, receptacle 5 containing the lowermost object 8 begins moving downward. Dispensing tube 12 also begins moving downward due to the force of gravity. Metering member 16 begins to be forced laterally inward toward the center of conduit 11. In FIG. 6G, receptacle 5 and dispensing tube 12 continue moving downward, and metering member 16 has partially re-entered the conduit to block the next object 8.

In FIG. 6H, receptacle 5 and dispensing tube 12 continue travelling downward, and dispensing tube 12 reaches its lower limit of travel as the retaining ring 18 contacts the upper surface 14a of support 14. Notch 13 and channel 15 are no longer aligned or partially aligned, and metering member 16 extends into conduit 11. Notch lip 13A prevents metering member 16 from excessive inward displacement. In FIG. 6I, receptacle 5 has been removed and the process is ready to repeat with an empty receptacle 5.

While there has been illustrated and described what is at present considered to be the preferred embodiment of the present invention, it will be understood by those skilled in the art that various changes and modifications may be made and equivalents may be substituted for elements thereof without departing from the true scope of the invention disclosed, but that the invention will include all embodiments falling within the scope of the claims.

I claim:

1. A dispenser comprising:
a. a support defining a vertical central bore and one or more support channels;
b. a dispensing tube comprising a first end and a second end, wherein the dispensing tube defines a conduit extending from the first end to the second end and further defines one or more notches, and wherein the dispensing tube is slidably positioned in the central bore of the support; and
c. one or more metering members wherein each metering member is positioned in a notch on the dispensing tube and wherein each metering member cooperates with one of the support channels when the support channel and dispensing tube notches are aligned.

2. The dispenser of claim 1 wherein the dispensing tube comprises a first blocking structure positioned at the first end of the dispensing tube and a second blocking structure positioned at the second end of the dispensing tube.

3. The dispenser of claim 2 wherein the first blocking structure comprises one or more retaining rings removably positioned around the dispensing tube.

4. The dispenser of claim 2 wherein the second blocking structure comprises an annular lip integral with the dispensing tube.

5. The dispenser of claim 1 wherein the metering member comprises a first hemispherical end and a second hemispherical end.

6. The dispenser of claim 5 wherein the metering member further comprises a first cross-section that is substantially circular and a second cross-section that is substantially oval.

7. The dispenser of claim 5 wherein the metering member further comprises a first cross-section that is substantially circular and a second cross-section that is substantially circular.

8. The dispenser of claim 1 wherein each notch formed by the dispensing tube is graduated in size such that a metering member positioned in each notch is prevented from laterally displacing entirely into the conduit formed by the dispensing tube.

9. The dispenser of claim 8 comprising an odd number of notches formed by the dispensing tube wherein each notch is positioned at an equal distance from the second end of the dispensing tube.

10. The dispenser of claim 8 comprising two or more notches formed by the dispensing tube wherein each notch is positioned at a different distance from the second end of the dispensing tube.

11. A dispenser consisting of:
a. a support defining a vertical central bore and one or more support channels;
b. a dispensing tube consisting of a first end and a second end, wherein the dispensing tube defines a conduit extending from the first end to the second end and further defines one or more notches, and wherein the dispensing tube is slidably positioned in the central bore of the support; and
c. one or more metering members wherein each metering member is positioned in a notch on the dispensing tube and wherein each metering member cooperates with one of the support channels when the support channel and dispensing tube notches are aligned.

12. The dispenser of claim 11 wherein the dispensing tube further consists of a first blocking structure positioned at the first end of the dispensing tube and a second blocking structure positioned at the second end of the dispensing tube.

13. The dispenser of claim 11 wherein the metering member comprises a first hemispherical end and a second hemispherical end.

14. The dispenser of claim 13 wherein the metering member further comprises a first cross-section that is substantially circular and a second cross-section that is substantially oval.

15. The dispenser of claim 13 wherein the metering member further comprises a first cross-section that is substantially circular and a second cross-section that is substantially circular.

16. The dispenser of claim 11 wherein each notch formed by the dispensing tube is graduated in size such that a metering member positioned in each notch is prevented from laterally displacing entirely into the conduit formed by the dispensing tube.

17. The dispenser of claim 16 comprising an odd number of notches formed by the dispensing tube wherein each notch is positioned at an equal distance from the second end of the dispensing tube.

18. The dispenser of claim 16 comprising two or more notches formed by the dispensing tube wherein each notch is positioned at a different distance from the second end of the dispensing tube.

19. The dispenser of claim 11 wherein the portion of the conduit at first end of the dispensing tube is tapered and wherein the portion of the conduit at the second end of the conduit is tapered.

20. A dispenser comprising:
a. a support defining a vertical central bore and one or more support channels;
b. a dispensing tube comprising a first end and a second end, wherein the dispensing tube defines a conduit extending from the first end of the dispensing tube to the second end of the dispensing tube, wherein the dispensing tube further defines one or more notches graduated in size, wherein the dispensing tube is slidably positioned in the central bore of the support, wherein the portion of the conduit at the first end of the dispensing tube is tapered, and wherein the portion of the conduit at the second end of the dispensing tube is tapered;
c. one or more metering members wherein each metering member comprises a first hemispherical end, a second hemispherical end, a first substantially circular cross-section, and a second substantially oval cross-section, wherein each metering member is positioned in a notch on the dispensing tube, and wherein each metering member cooperates with one of the support channels when the support channel and dispensing tube notches are aligned.
d. one or more retaining rings positioned at the first end of the dispensing tube; and
e. an annular lip integral with the second end of the dispensing tube.
